(19) United States
(12) Patent Application Publication
(10) Pub. No.: US 2016/0180294 A1
(43) Pub. Date: Jun. 23, 2016

(54) SYSTEM AND METHOD FOR CREATING A CALENDAR OF COMPLIANCE TASKS FOR A BENEFIT PLAN

(71) Applicant: Xerox Corporation, Norwalk, CT (US)

(72) Inventors: Tamara M Simon, Bethesda, MD (US); Andrew D Eisner, Oceanside, NY (US)

(73) Assignee: Xerox Corporation

(21) Appl. No.: 14/734,935

(22) Filed: Jun. 9, 2015

Related U.S. Application Data
(60) Provisional application No. 62/096,015, filed on Dec. 23, 2014.

(51) Int. Cl. G06Q 10/10

(52) U.S. Cl. CPC G06Q 10/1057

(57) ABSTRACT

The disclosed embodiments include a system and method for generating a customized calendar of compliance tasks associated with administering a benefit plan. The system can create and store calendars for any number of plans of any type including defined benefit, defined contribution, and health and welfare plans. The system can be customized based on the requirements of a specific plan, country, or client. The system can be configured to send out reminders regarding calendar events. In some embodiments, the system may also be configured to automatically perform certain events such as, but not limited to, automatically retrieve information, fill out forms, and submit forms with or without user interaction. Thus, using the disclosed embodiments, plan sponsors are more easily able to comply with all the requirements set forth for a benefit plan.

### BACKGROUND

The present disclosure relates generally to a system configured to generate a customized calendar of compliance tasks associated with administering a benefit plan.

Benefit plans such as employee benefit plans that have tax-qualified status (meaning plan sponsors receive tax-favored treatment on money they contribute to the plan to pay benefits promised to employees) must adhere to strict governmental rules. Many of these rules are compliance related, such as filing various forms to government agencies, and sending required notices to employees. The due dates for the majority of these compliance items are dependent on the characteristics of each particular plan (such as plan year start date, fiscal year start date, does the plan have loan provisions, does the plan allow for lump sum distributions). Plan sponsors failing to timely fulfill their compliance obligations are subject to penalties, ranging from fines to plans having their tax-favored status revoked, which may result in all past contributions becoming taxable.

To help keep track of all compliance items that they are responsible for, plan sponsors rely on generic lists or calendars, on reminders that they enter individually on their own calendars (either online or paper), or trust others (such as a consultant) to remind them. These methods are unreliable and have multiple chances of reminders not being set up properly or simply falling through the cracks.

### BRIEF SUMMARY OF THE DISCLOSED EMBODIMENTS

The disclosed embodiments include a system and method for generating a customized calendar of compliance tasks associated with administering a benefit plan. The system can create and store calendars for any number of plans of any type such as, but not limited to, defined benefit, defined contribution, and health and welfare plans. Because employers have different plans with a variety of provisions and characteristics, some compliance events only apply to certain plans and others are due at different times for different plans. Plan sponsors have to pay attention to different deadlines and regulations, and therefore a customized calendar is very useful to remind them of compliance events due for their particular plans.

In one embodiment, the system operates on a network and provides an online application that enables plan administrators or any authorized user to configure and generate a customized calendar of compliance tasks associated with administering a benefit plan. For instance, in some embodiments, a plan administrator/sponsor or other authorized users provide answers to a set of questions (e.g., plan year start date, does the plan provide for participant loans, etc.) for configuring the system in generating a customized calendar of compliance tasks associated with administering a benefit plan that are specific to their needs. At the most granular level, a question set can be defined at a client-plan type level. For instance, each of the various plan types including, but not limited to, defined benefit (DB) plans, defined contribution (DC) plans, and health and welfare (H&W) plans has a unique question set. In generating the customized calendar of compliance related tasks, the responses entered for a particular plan determine (1) what events are populated onto the calendar for that plan, and (2) what the due dates and reminder dates are for those events.

For example, specific embodiments disclosed herein include a system that is configured to generate a customized calendar of compliance tasks associated with administering a benefit plan. In one embodiment, the system includes memory for storing computer executable instructions and data; and a processor for executing the computer executable instructions. For instance, in one embodiment, the computer executable instructions comprise instructions for receiving user-input indicating a user selection of the benefit plan; retrieving benefit plan data associated with the benefit plan; receiving answer data indicating answers corresponding to questions associated with the benefit plan; and generating the customized calendar of compliance tasks associated with administering the benefit plan based on the answer data and the benefit plan data.

In some embodiments, the computer executable instructions further comprise instructions for performing, in no particular order, one or more of the following steps: verifying that that a user has permission to modify the answer data; retrieving a calendar template associated with the benefit plan; identifying a question set containing the questions associated with the benefit plan; presenting the questions associated with the benefit plan to a user; receiving updated answer data indicating changes to the answers corresponding to the questions associated with the benefit plan; updating the customized calendar of compliance tasks associated with administering the benefit plan based on the updated answer data; generating a reminder event for a compliance task, wherein the reminder event is configured to send a reminder message to a plurality of specified recipients; and automatically performing a compliance task prior to a due date of the compliance task.

Another disclosed embodiment includes a computer-implemented method for generating a customized calendar of compliance tasks associated with administering a benefit plan. In one embodiment, the method includes the steps of receiving user-input indicating a user selection of the benefit plan; retrieving benefit plan data associated with the benefit plan, wherein the benefit plan data includes requirements associated with the benefit plan; determining whether the benefit plan is associated with a question set; identifying the question set containing questions associated with the benefit plan in response to a determination that the benefit plan is associated with the question set; and presenting the questions associated with the benefit plan to a user; receiving answer data indicating answers corresponding to questions associated with the benefit plan; and generating, using a processor, the customized calendar of compliance tasks associated with administering the benefit plan using the benefit plan data and the answer data; generating a reminder event for a compliance task based on the customized calendar of compliance tasks associated with administering the benefit plan, wherein the reminder event is configured to send a reminder message to a plurality of specified recipients.

Still, another disclosed embodiment includes a computer-readable storage media having stored thereon computer-executable instructions that when executed by a processor of a system, enables the system to receive user-input indicating a user selection of the benefit plan; receive answer data indicating answers corresponding to questions associated with the benefit plan; and generate the customized calendar of compliance tasks associated with administering the benefit plan based on the answer data.

Additional details of the disclosed embodiments are provided below in the detailed description and corresponding drawings.

### BRIEF DESCRIPTION OF THE DRAWINGS

Illustrative embodiments of the present invention are described in detail below with reference to the attached drawing figures, which are incorporated by reference herein, and wherein:

FIG. 1 illustrates a system for generating a customized calendar of compliance tasks associated with administering a benefit plan in accordance with one embodiment;

FIG. 2 is a block diagram illustrating certain components of a system for generating a customized calendar of compliance tasks associated with administering a benefit plan in accordance with one embodiment;

FIG. 3 is a flowchart illustrating a process for creating and updating a customized calendar of compliance tasks associated with administering a benefit plan in accordance with one embodiment;

FIG. 4 is a flowchart illustrating a template recurrence process in accordance with one embodiment;

FIG. 5 is a flowchart illustrating a reminder process in accordance with one embodiment;

FIG. 6 illustrates an example of a user interface for editing or inputting client information in accordance with one embodiment;

FIG. 7 illustrates an example of a user interface for displaying a calendar catalog in accordance with one embodiment;

FIG. 8 illustrates examples of data tables in accordance with one embodiment;

FIG. 9 illustrates an example of a user interface for managing a calendar template in accordance with one embodiment;

FIG. 10 is a flowchart illustrating a process for managing a calendar template in accordance with one embodiment;

FIG. 11 is a flowchart illustrating a process for creating and editing question set answers in accordance with one embodiment;

FIG. 12 is a flowchart illustrating a process for viewing or editing a question set in accordance with one embodiment;

FIGS. 13-15 illustrate examples of a question set in accordance with one embodiment;

FIG. 16 illustrates a user interface for enabling a user to enter or edit a calendar task appointment in accordance with one embodiment; and

FIG. 17 illustrates an example of a user interface for displaying a customized calendar of compliance tasks associated with administering a benefit plan in accordance with one embodiment.

The illustrated figures are only exemplary and are not intended to assert or imply any limitation with regard to the environment, architecture, design, or process in which different embodiments may be implemented.

### DETAILED DESCRIPTION

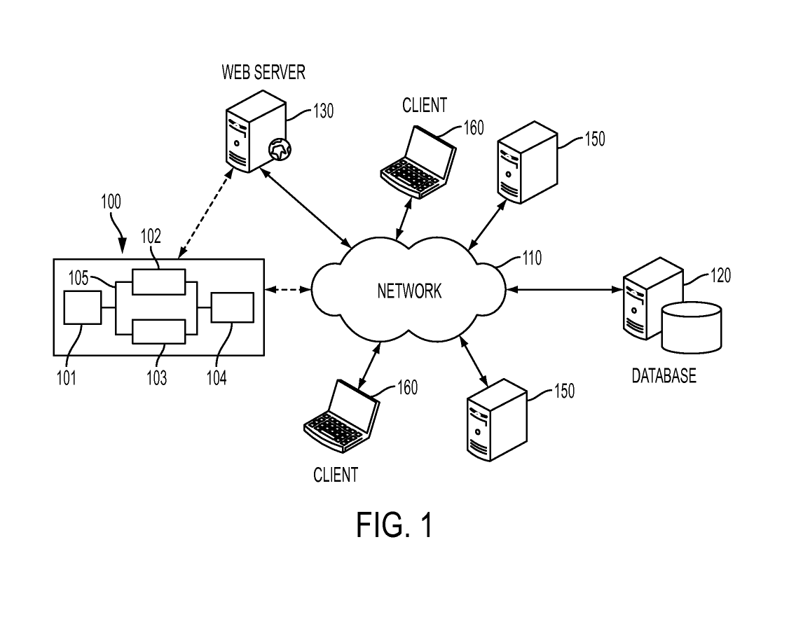

FIG. 1 illustrates a system 100 for generating a customized calendar of compliance tasks associated with administering a benefit plan in accordance with one embodiment. As stated above, in one embodiment, the system operates on a network and provides an online application that enables plan administrators or any authorized user to configure and generate a customized calendar of compliance tasks associated with administering a benefit plan. For example, in the depicted embodiment, the system 100 may communicate over a communication network 110 with a number of other devices including, but not limited to, a database 120, a web server 130, and one or more client devices 160.

The communication network 110 may be any type of wired or wireless connection, which may include one or more public or private networks or some combination thereof, such as the Internet, an intranet, a mobile cellular or data network, or any other network operable to transmit data to and from the system 100.

In one embodiment, the system 100 comprises components including one or more processors 101, a computer-readable storage media 102, an input/output interface 103, and a network interface 104. Each of the components of the system 100 communicates via a systems bus 105 that transfers data between the components. The processors 101 are configured to process data and execute computer-executable instructions. These instructions may include, but are not limited to, machine code instructions, bytecode for a software interpreter, object code, and source code in a high-level programming language.

Data and computer-executable instructions are stored in the computer-readable storage media 102. The computer-readable storage media 102 may be any appropriate memory device or computer storage media, such as, but not limited to, a hard disk drive, random access memory, read only memory, electrically erasable programmable read-only memory, flash memory or other memory technology, compact disc-read only memory, digital versatile disks or other optical disk storage, magnetic cassettes, magnetic tape, magnetic disk storage or other magnetic storage devices. In some embodiments, the data and executable instructions may be stored on a component or device that is external to the system 100 such as on the cloud or on an external memory drive.

The input/output (I/O) interface 103 comprises an input interface for receiving user input or data from one or more peripheral devices. For example, the I/O interface 103 may receive user input or data from one or more input devices such as, but not limited to, a keyboard, mouse, touch screen, microphone, scanner, and/or a camera. The I/O interface 103 also comprises an output interface for outputting information to one or more device or component associated with the system 100. For example, the I/O interface 103 may output data or other information to a display device for displaying information to a user, another system, and/or to a printer.

The network interface 104 may include one or more wired or wireless interfaces such as, for example, an Ethernet port or a wireless transceiver for enabling the system 100 to send and receive data over the network 110. The network interface 104 is not limited to any particular communication protocol or hardware interface. For example, in one embodiment, as will be further described herein, the system 100 may query or communicate with one or more private or public database 120 that contains client data, benefit plan data including, but not limited to, requirements, calendar templates, question sets, weekend and holiday rules, and user roles associated with a benefit plan.

The database 120 may contain information provided and/or maintained by a single entity or by a combination of entities including one or more independent third parties. Still, in certain embodiments, the system 100 may store all data in a local data storage unit or database to eliminate the need to access the network 110 to retrieve the data.

Besides the database 120, the network interface 104 may also enable the system 100 to communicate with other devices over the network 110. For example, in certain embodiments, the system 100 may communicate with a web server 130 for providing the services disclosed herein as a web application or website (also commonly referred to as a webpage or web portal) to one or more clients 160. For example, in some embodiments, the system 100 may operate as a back end server that processes and provides all the services described herein, while the web server 130 provides the front end services of gathering and displaying information using one or more user interfaces/webpages. Still, in certain embodiments, the system 100 may provide services to the one or more clients 160 directly without the use of the web server 130.

Additionally, in some embodiments, the system 100 may be a client or end user device such as but not limited to a personal computer, mobile computer, laptop, smart phone, personal digital assistant, or any other computing device that has locally stored computer executable instructions for generating a customized calendar of compliance tasks associated with administering a benefit plan in accordance with the embodiments disclosed herein. For instance, alternatively to or in addition to providing the embodiments disclosed herein as an online application, in certain embodiments, the embodiments described herein may be locally installed on a client/end-user computing device as an application or mobile application.

Additionally, the system 100 may communicate either locally or over the network 110 with any number of other machines/devices 150 such as, but not limited to an email server, accounting server, and a reporting server. For example, in some embodiments, the system 100 may be further configured to communicate with an accounting server for billing a client for services rendered, or a government reporting server for retrieving or filing reports or other documents, or an email server or other messaging devices for sending information or reminders out to one or more users.

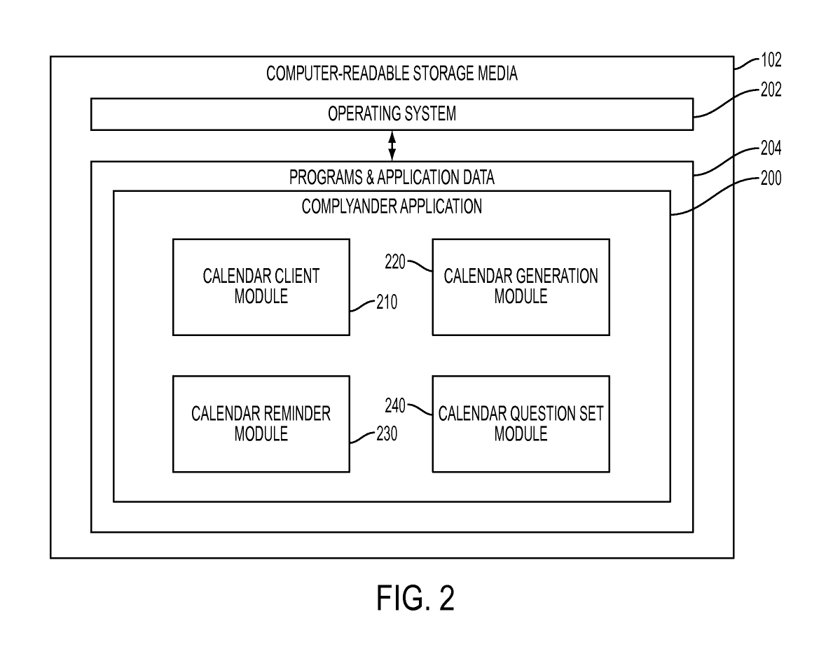

FIG. 2 is a block diagram illustrating certain components of a compliance calendar generator application 200 in accordance with one embodiment. The compliance calendar generator application 200 comprises of data and computer executable instructions stored in the computer-readable storage media 102, such as main memory or a hard drive, that when executed performs the processes disclosed herein. In certain embodiments, the computer-readable storage 102 media may also store data and computer executable instructions associated with an operating system 202 and/or one or more applications 204. Still, in certain embodiments, the compliance calendar generator application 200 may be a component of a bigger application.

In the depicted embodiment, the compliance calendar generator application 200 includes examples of the types of classes, objects, or software modules that may be employed to perform the processes disclosed herein. For instance, in one embodiment, the compliance calendar generator application 200 may include a calendar client module 210, a calendar generation module 220, a calendar reminder module 230, and a calendar question set module 240.

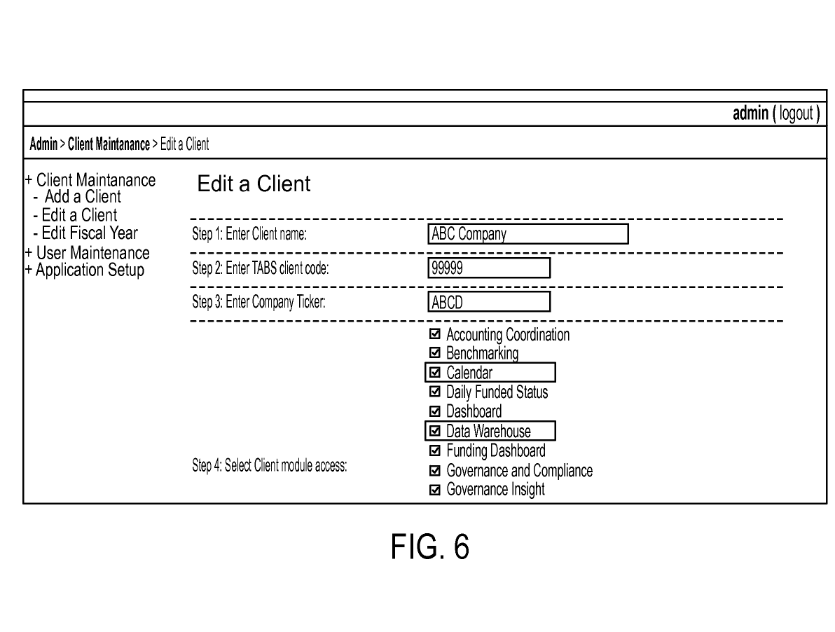

In one embodiment, the calendar client module 210 includes data and executable instructions for maintaining client information. For instance, FIG. 6 illustrates an example of a user interface and may be generated by the calendar client module 210 for receiving client information in accordance with one embodiment. As shown in the example illustration, client information may include a client name, a client code, a company ticker, and one or more functions assigned to the client. Other client information data may include, but are not limited to, client contact information, authorized users, user roles, client access information such as passwords and usernames, calendars associated with a particular client, and billing information. In certain embodiments, the calendar client module 210 may also include data and executable instructions for executing a calendar template management process, as will be further described, for managing a plurality of calendar templates.

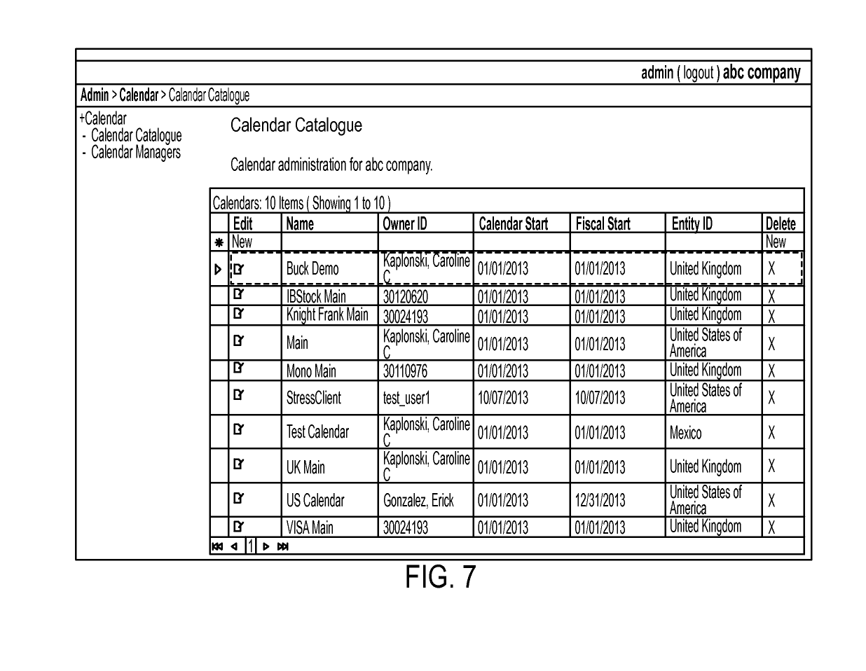

Still, in certain embodiments, the calendar client module 210 may include instructions for maintaining or generating a calendar catalog that contains a listing of all calendars for one or more clients as depicted in FIG. 7. For instance, in one embodiment, the calendar catalog may list the names of all available calendars and corresponding owner, start date, fiscal start date, country code. The calendar catalog may provide options for deleting, creating, or editing one or more selected calendars.

In one embodiment, the calendar generation module 220 includes data and executable instructions for generating a customized calendar of compliance tasks associated with administering a benefit plan. For instance, as will be further described, the calendar generation module 220 may include instructions for generating, managing, determining, and retrieving calendar templates, and gathering and retrieving data for generating calendar events based on a particular calendar template. Examples of compliance related tasks include, but are not limited to, providing notice to interested parties, submitting particular forms or documents (e.g., Form 945 or Form 5300) to a government entity such as the Internal Revenue Service, start and end dates for enrollment, and deadlines for distributing forms to employees.

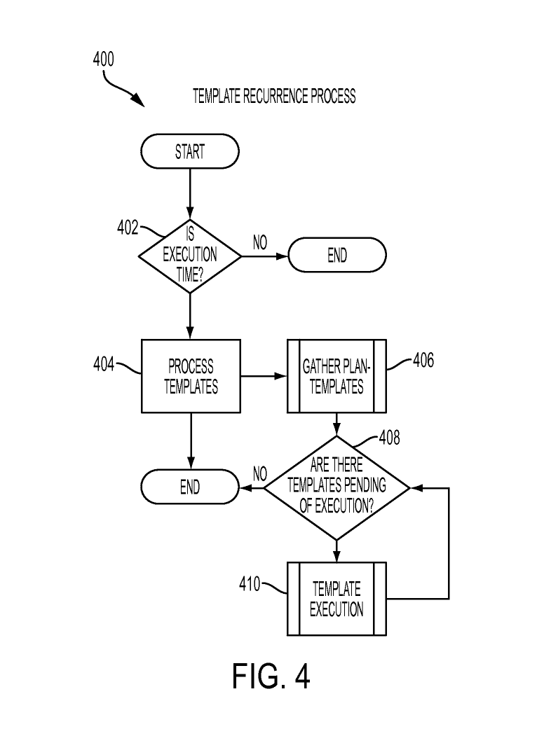

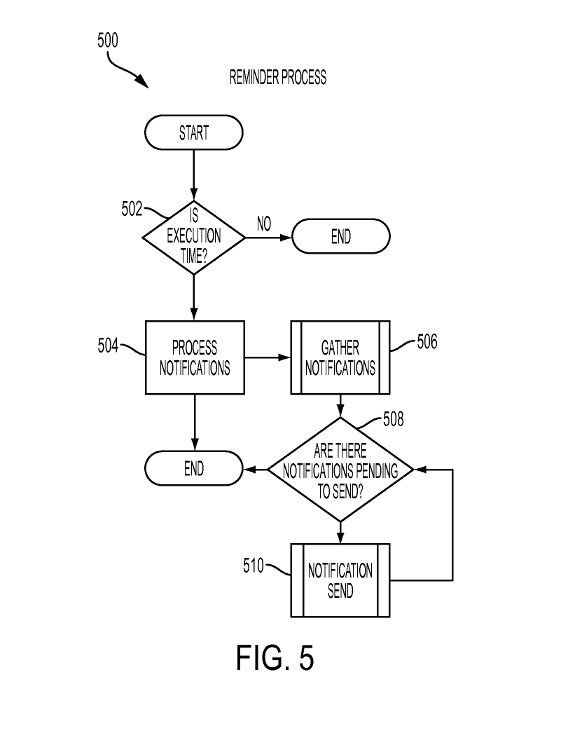

The calendar reminder module 230 may include data and executable instructions for performing a template recurrence process and reminder process as illustrated and further described below in reference to FIGS. 4 and 5.

The calendar question set module 240 may include data and executable instructions for generating and storing one or more question sets for a plurality of plans and for a plurality of countries. The question sets solicit answers that provide plan specific information for generating the plan calendars. For example, in one embodiment, the system uses the answers to the question sets to determine whether certain events are included on the calendar, a due date for a calendar event, and reminder settings such as dates and recipients associated with providing a reminder. In one embodiment, reminders for each calendar event can be targeted to different individuals to be received on different dates. For example, for a certain calendar event, a benefit plan participant may receive a reminder two weeks in advance, while a plan administrator may receive the same reminder a month in advance.

In one embodiment, the system uses different question sets based on the plan type. For example, in one embodiment, the system uses a first question set for defined benefit plans, a second question set for defined contribution plans, and a third question set for health and welfare plans. Each of the question set include some common questions such as a plan start date and end date. However, each question set differs based on information needed to be gathered for a particular plan type. For example, a question asking if a plan contains a loan provision applies to a defined contribution plan, but not to a health and welfare plan, so it would in the question set for the defined contribution plan and not for the health and welfare plan. Alternatively, in certain embodiments, the system may use a global question set for all plans.

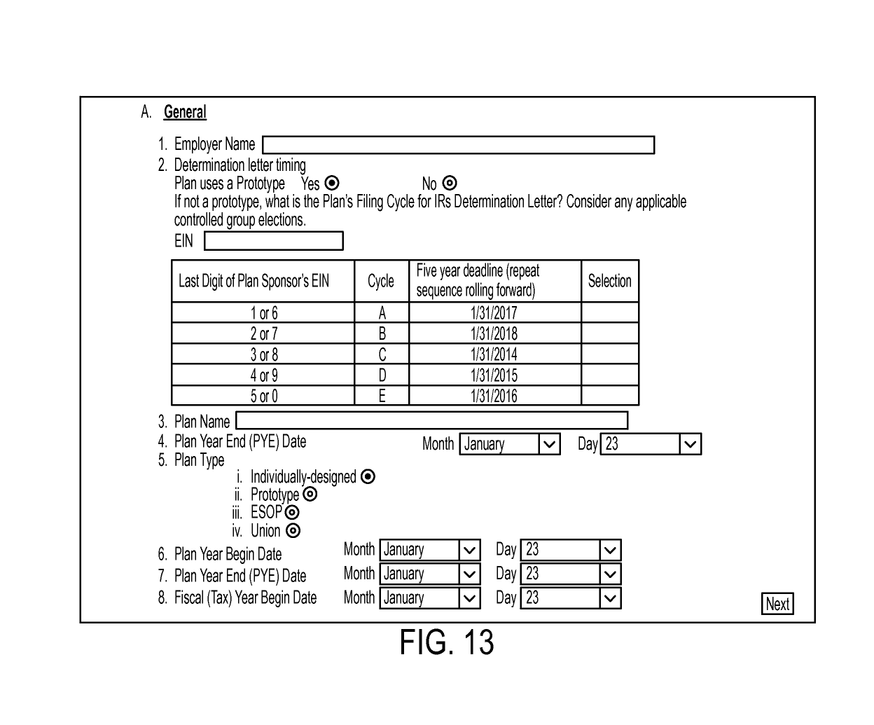

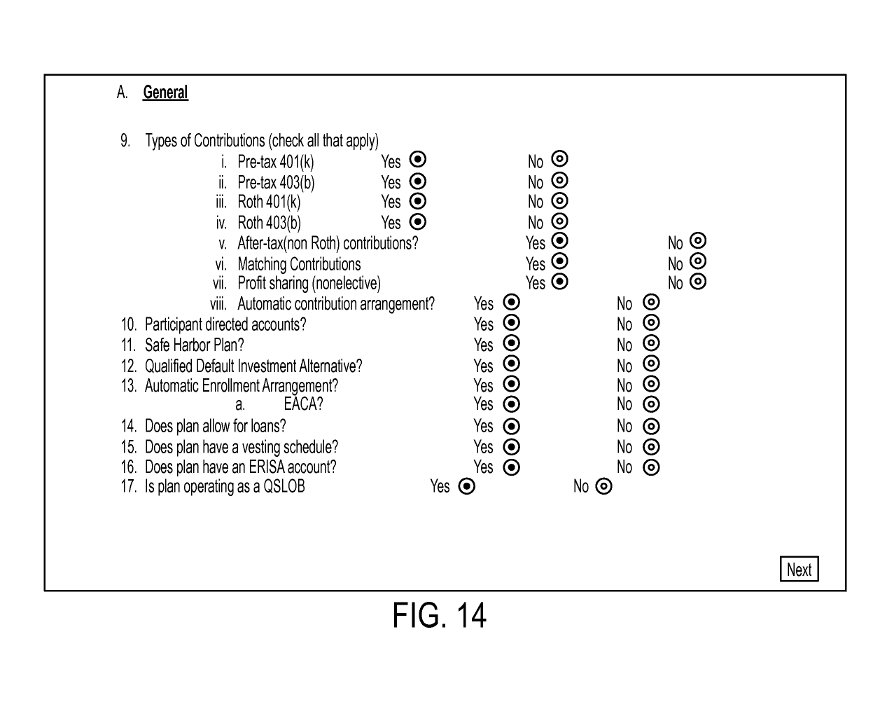

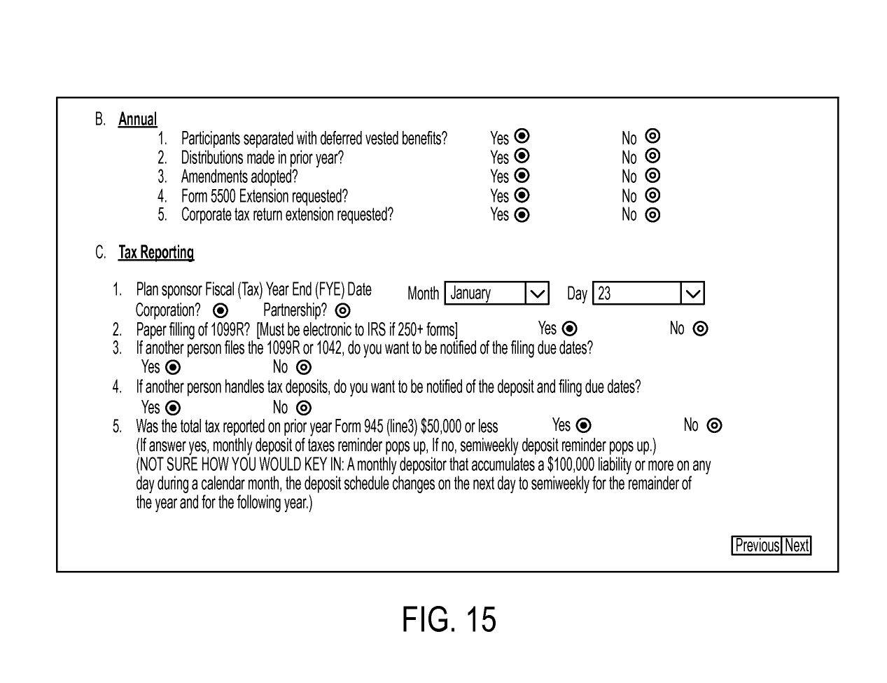

The calendar question set module 240 may also include data and executable instructions for determining whether a user is authorized to answer or edit questions. An example question set is illustrated and described further below in FIGS. 13-15. In addition, the calendar question set module 240 may include executable instructions for determining or identifying which question set is utilized for a particular plan or for a particular country.

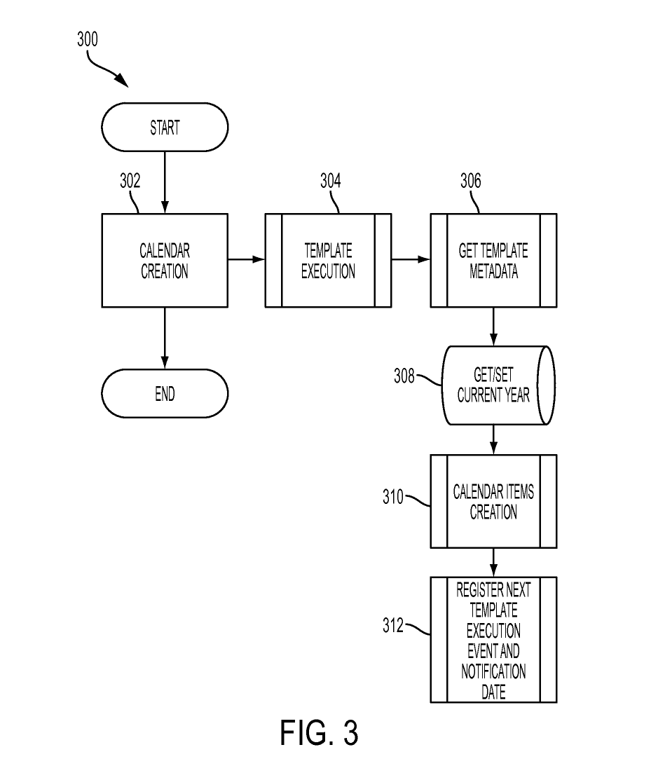

FIG. 3 is a flowchart illustrating a process 300 for creating and updating a customized calendar of compliance tasks associated with administering a benefit plan in accordance with one embodiment. Once a user has initiated or been granted access to the system, for example, by verifying username and password, the process 300 executes instructions at calendar creation block 302 to enable a user to create or update a customized calendar. For instance, in one embodiment, the process may present the user with plan selection or calendar view options, wherein a user may create or update the calendar template of a calendar. For example, in one embodiment, the calendar template of a calendar includes answers to a question set that is used in generating and populating a calendar.

If the user chooses to create or edit a calendar, the process initiates template execution block 304 for determining and retrieving the appropriate calendar template for a particular plan associated with the user. In one embodiment, the calendar template plan may be specific for a particular country. For instance, in one embodiment, the system stores a plurality of calendar templates based on particular country requirements for each plan type.

In one embodiment, if the user chooses the plan selection option, and if the user has privileges to create plan calendars, the process presents the user with three plan options: 1) plan type not related to question set/template; 2) plan type related to question set/template mandatory; and 3) plan type related to question set/template optional. For example, certain non-US plans are not associated with any question sets for which there are and therefore the disclosed calendar creation process does not apply. For these plans, an administrator would manually populate a list of standard events to a generic calendar with no customization.

Examples of plan types that have mandatory question set associated with them include US DB, DC or H&W plans. When one of these plans is selected, a mandatory question set is automatically launched, which will trigger the creation of a compliance calendar. For instance, in one embodiment, the process will present the user with a set of specific questions associated with the particular plan, and utilize the responses to the questions to generate the calendar entries according to the specific template. Alternatively, in certain embodiments, the user may have previously provided answers to one or more question sets. In these embodiments, the stored answers are retrieved from memory in response to the user selecting the option to create a calendar.

In one embodiment, under option 3, there are currently some plans including, but not limited to, some non-US plans for which there is a limited, generic question set that can be applied. For example, in one embodiment, this question set might only contain two or three generic questions, such as “When does the plan year end?” For these plans, there would be an option to use the limited, generic question set. In one embodiment, if the optional question set is not selected, an administrator would manually populate a list of standard events to a generic calendar with no customization.

In one embodiment, any modification or creation of a calendar for a particular plan for a client overrides or deletes any calendar item previously created based on a prior set of answers for the particular plan of the client. In certain embodiments, a warning may be presented to make the user aware that any update to those items will be lost because the new set of answers may have the same data as it original counterpart.

Still, in certain embodiments, the process may be configured to apply different approaches in regard to a user modifying the answers to a question set. For instance, in one embodiment, the system may be configured to delete everything in the calendar created only by the template execution; or delete everything in the calendar whether created by the template execution or manually added/updated; or delete everything in the calendar created by the template execution with a start date greater than the execution date; or delete everything in the calendar whether created by the template execution or manually added/updated with a start date greater than the execution date.

Similar options would apply when updating a question set, or creating a new one to replace an existing one. In one embodiment, modifying the answers to a question set will trigger an update to be performed on any plan calendar tied to the updated question set.

The process at block 306 retrieves template metadata for a selected calendar template plan. Non-limiting examples of template metadata include information about events associated with the calendar template plan such as, but not limited to, event name, types of forms that need to be submitted, start dates, deadlines, weekend and holiday rules, reminder dates, category rules, and modification rules. For example, in one embodiment, for events with mandated deadlines such as, but not limited to, those by government agencies, the due date field is locked from editing by users.

In one embodiment, the category rules designate an event to a particular category such as actuarial and funding; administration; contributions; forms; investment; participant communications; trustees meetings; trustees report. The modification rules specify whether an event can be modified by the user. The weekend and holiday rules specify what happens if a deadline falls on a weekend or a holiday. For example, the weekend and holiday rules for a specific plan will determine whether a filing requirement must be submitted on a weekday before a deadline, whether it can be submitted the day of, or whether it can be submitted next business day. In some cases, the weekend and holiday rules may indicate that there is no weekend or holiday rule specified for the particular plan.

At block 308, the process retrieves and sets the current year for the calendar. For instance, in one embodiment, part of the data saved when saving answers to the question set will be a date when the system should create the calendar events for the next time cycle. The date may be a specific date or may be a time period such as, but not limited to, 3 months before the last day of the current plan. In one embodiment, the date to populate the next plan year calendar is set in the system as a global setting for all plans. Alternatively, in some embodiments, the date to populate the next plan year calendar may be individualized by a client or based on a particular plan. The time cycle is the length of time that events are created for during each calendar generation. For example, in one embodiment, the process generates 1 year of events per execution. For example, the process may generate events from Jan. 1, 2015 to Jan. 1, 2016. The date range may be any date and is not limited to the beginning and end of a calendar year. Similarly, in other embodiments, the process may generate any term of events per execution such as, but not limited to, 6 months, 9 months, 18 months, 2 years, etc. In some embodiments, this may be a user customizable variable. In addition, in some embodiments, the process may also include a constant or user defined variable for indicating a date or time period as to when a reminder message should be sent to advise a user or group of users that a template is about to run. This reminder will enable the user or group users to update, if necessary, any question set answers. In one embodiment, the reminder message includes a request for the legal holidays table for the next year. Alternatively, in some embodiments, the legal holidays table may be automatically retrieved from one or more network sources.

The process at block 310 creates the calendar items based on the retrieved template metadata and calendar data. For example, based on the particular plan type, the process retrieves all the particular plan requirements/rules including, but not limited to, types of forms that need to be submitted, deadlines, and weekend and holiday rules. The process uses the retrieved information to populate the calendar.

At block 312, the process registers the next template execution event and notification date. This step as will be further explained determines when the calendar would be updated based on new or existing answers, and when a notification of the update will be sent to one or more users.

FIG. 4 is a flowchart illustrating a template recurrence process 400 in accordance with one embodiment for updating or generating the subsequent calendar period for a plan. In other words, in accordance with the disclosed embodiments, a compliance calendar can be perpetually generated automatically. In certain embodiments, a user or plan administrator may disable this feature.

In one embodiment, the process 400 is periodically executed to determine whether it is time to run a template recurrence at block 402. In one embodiment, the time period for periodically executing this process may be a constant such as, but not limited to, yearly, monthly, weekly, daily, or a particular date. In other embodiments, the time period may be a user defined variable. Still, in other embodiments, the template recurrence process 400 may be configured to run at a specified time such as three months before the end of the current calendar for a plan.

In one embodiment, the process makes the determination on whether it is time to run a template recurrence by identifying certain calendar items created through the template that are grouped together. For instance, in one embodiment, all government reporting events may be grouped together. If an event within this group that needs to be created is set to occur on November 1^{st}, then the process will make the determination that it is time to run the template recurrence prior to that date. In other words, the process must execute prior to an event date so that reminders can be set up for the calendared event. In other embodiments, a user may manually force the execution of a template run.

If the process determines that it is not time to execute a template recurrence run, the process terminates. Otherwise, if the process determines that it is time to execute a template recurrence run, it will execute the template recurrence process at block 404 with the current set of answers.

At block 406, the process gathers calendar templates and determines whether there are templates pending execution at block 408. If there are templates pending execution, the process will perform the template execution at block 410. The process repeats the cycle until there are no templates pending execution. At which point, the process 400 ends.

In connection with the template recurrence process, FIG. 5 is a flowchart illustrating a reminder process 500 in accordance with one embodiment. The process 500 is periodically executed to determine at block 502 whether it is time to execute the reminder process to remind users that template execution is approaching. This will enable users to update any information/answers for generating the new template calendar. Similar to process 400, the time period for periodically executing this process may be a constant (e.g. yearly, monthly, weekly, daily, hourly, a particular date, etc.) or it may be a user defined variable. Although, in certain embodiments, in situations where a user did not update answers prior to the recurrence service run, an option may be provided to the user to override a current set of events at any time.

If it is time to execute the process, the process at block 504 executes the process to gather notifications at block 506. The process determines whether any notifications need to be sent out at block 508, and if so, the process sends the notification at block 510. The process repeats the cycle until all notifications are sent, at which point the process 500 ends.

In one embodiment, the process generates a log record in response to a template being executed either manually or during the automated process. In one embodiment, the log record saves details of changes made to a calendar. For example, when a template update is executed, existing calendar items may change. The “log record” documents what events were changed, what the changes were, and when the changes were made. This way if a user notes that an event does not appear as they remember seeing it in the past, the log record will have a record of the change (why, what, and when).

In certain embodiments, the system may be configured to enable users to input answers in advance. In these embodiments, the user may set a date specifying when new answers go live or alternatively, the new answers may be used automatically when the template recurrence process executes.

Still, in certain embodiments, the system may be configured to execute instructions to perform a similar reminder process for each calendar event. For instance, in one embodiment, the system may be configured to provide a monthly reminder, and weekly follow-up reminders as a calendar event approaches. This reminder may be sent to a single user, or a plurality of designated recipients. In addition, in certain embodiments, the system may be configured to send reminders to different individuals on different dates.

In some embodiments, the system may also be configured to automatically perform certain events in lieu of or in addition to providing reminders. For example, in some embodiments, if a particular form needs to be sent to a government agency by a certain date, the system may be configured to retrieve the necessary form, retrieve the necessary information for filling out the form from one or more databases, automatically fill out the form, and electronically submit the form to the appropriate agency. The system may provide notice to one or more users that the form has been submitted and if available, confirmation that the form has been received. In certain embodiments, the system may be configured to automatically fill out the form with the need data, but not submit the form until a user has confirmed the accuracy of the data. Still, in some embodiments, if additional information is needed for a particular form, the system may be configured to automatically send a request to one or more users requesting the additional information. Other automated tasks may include, but are not limited to, sending out notifications to employees and updating plan requirements.

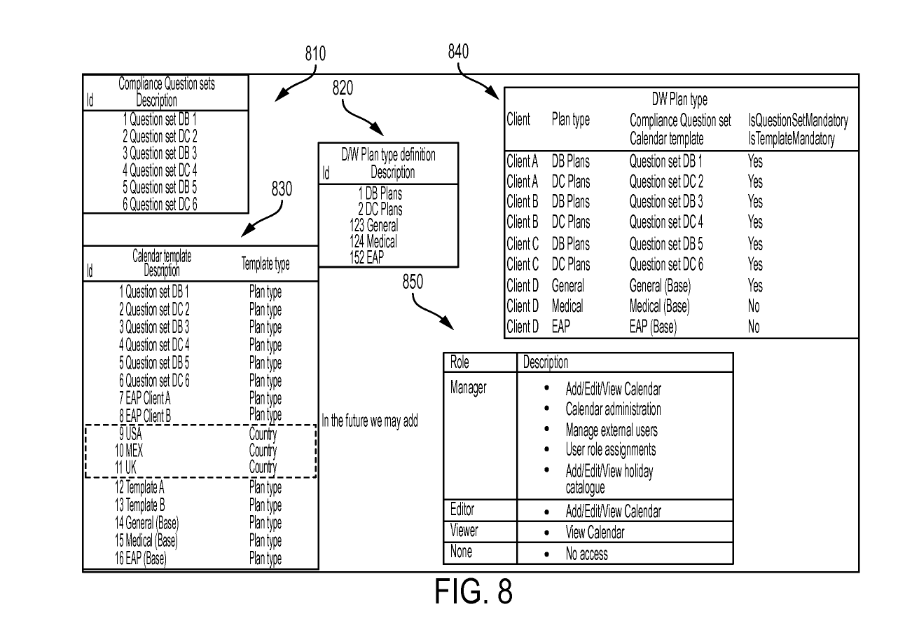

Non-limiting examples of data tables that may be used in the process of generating a customized calendar of compliance tasks associated with administering a benefit plan in accordance with the disclosed embodiments are depicted in FIG. 8. For example, the compliance calendar generator application 200 may store and access a compliance question set table 810 that stores a plurality of question sets, a plan type definition data table 820 that stores information on a plurality of plans, a calendar template data table 830 that stores information that associates question sets to a particular plan type or country, a client data table 840 that associates clients with certain data plans and question sets. In one embodiment, plan types related to a client will identify the question set or template that it is tied to. In the depicted embodiment, the client data table 840 includes an “IsTemplateMandatory” field that indicates the need to execute the template execution as soon as the calendar is created or prior to any manual input.

In addition, user data table 850 indicates roles that may be assigned to particular users and their corresponding capabilities. For example, in one embodiment, a user may be assigned a manager role, in which case, the user may add, edit, and view a calendar; perform calendar administration such as assigning and managing external users; assign roles to other users; and add, edit, and view holiday and weekend rules. In contrast, in one embodiment, a user assigned as an editor may only add, edit, and view a calendar. Still, certain users may be assigned a viewer role that enables them to simply view a calendar, but perform no editing. In some embodiments, whether a user can edit is broken down to specific tasks. For example, in one embodiment, editing may be enable or disabled for editing question sets, editing event details, editing legal due dates, etc.

In one embodiment, if a user is not assigned a particular role, the user has no access to a particular calendar. Alternatively, in some embodiments, certain users may be expressly assigned a non-user role that provides them no access. Still, in certain embodiments, user roles may be plan specific. For example, in one embodiment, a user with the editor role may be able to continue creating calendars for medical plans, but for defined contribution (DC) plans, only manager role members would be able to create calendars.

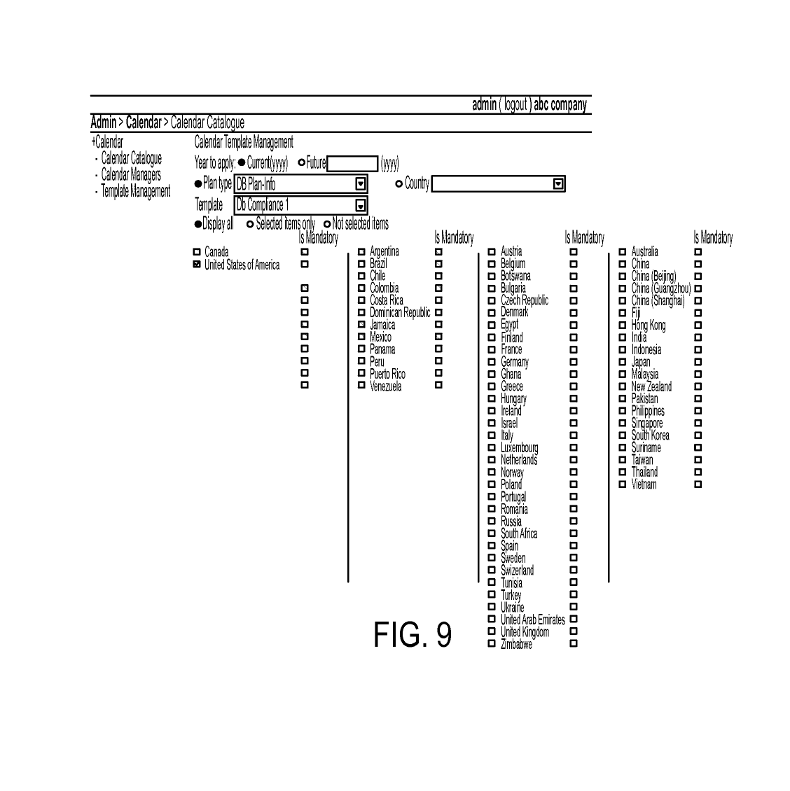

FIG. 9 illustrates an example of a user interface for managing a calendar template in accordance with one embodiment. For instance, the data contained in the data tables in FIG. 8 may be gathered using one or more user interfaces such as the user interface depicted in FIG. 9. In one embodiment, those countries that already have a template tied to, but not in use will be grayed out. For them to be active, the user should delete the current relationship before creating any other. In some embodiments, when adding/changing a template relationship, the user will be given the option of applying the change to a current period or a previous plan year. The start and end of the year dates can be defined according to the templates. For instance, in some cases, there are items that need to be created for the previous year. Also, in some embodiments, when changing a template relationship, besides validating existing events that may be affected, a notification about the change can be sent to one or more designated persons. For example, in one embodiment, notice may be sent to a user that has been granted access for changing or generating a calendar for a given client. In some embodiments, the data may also be automatically retrieved from one or more databases or servers over a private or public network.

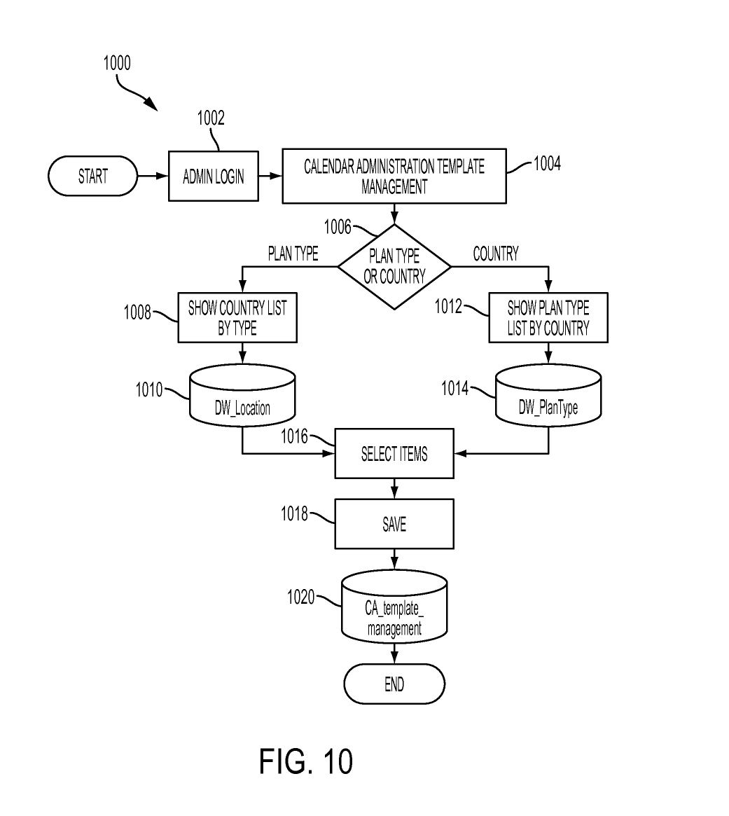

FIG. 10 is a flowchart illustrating a process 1000 for managing a calendar template in accordance with one embodiment. For instance, in some embodiments, when configuring the system, a user is able to define the related template at a plan type or country level.

The process 1000 begins at block 1002 by verifying whether an authorized user logged onto the system has admin rights for managing calendar templates. Once the user is verified, the process enters the calendar administration template management block 1004, wherein the user is presented with the option of either selecting a plan type or a country at block 1006. If the user selects the plan type, the process retrieves data from the location database 1010, and displays the country list by type at block 1008. If the user selects country, the processor retrieves data from the plan type database 1014, and displays the plan type list by country at block 1012. At block 1016, the process receives a user selection of one of the items displayed in the list. At block 1018, the process saves the user selection in a template management database 1020, with process 1000 terminating thereafter.

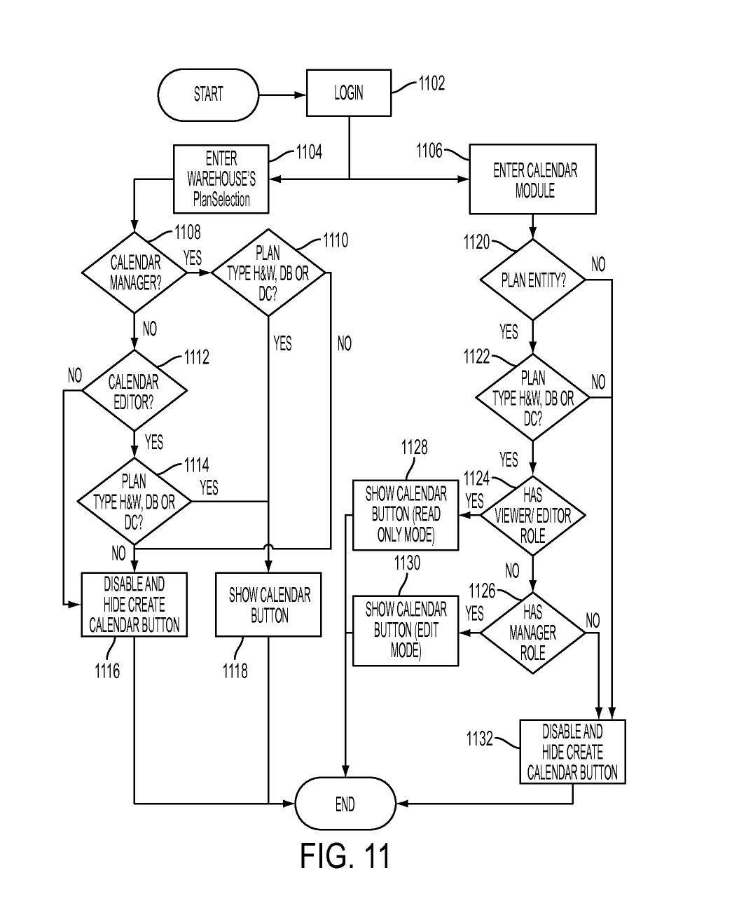

FIG. 11 is a flowchart illustrating a process 1100 for creating, viewing, and editing a question set in accordance with one embodiment. The process begins at block 1102 where user login information is received. The process determines based on the user login information whether a user is authorized to access the system. In the depicted embodiment, if the process determines that the user is authorized to access the system, the user is presented with the option of either entering the warehouse plan selection block 1104 or calendar module block 1106.

If the user selects the warehouse plan selection block 1104, the process determines at block 1108 whether the user is a calendar manager. If the user is a calendar manager, the process at block 1110 determines whether the plan type is one of a DB, DC, or H&W plan. If so, the process displays an option such as a “create calendar” button for enabling a user to create question set answers. If at block 110, the process determines that the plan is not one of the listed plans, the process disables and hides the option for enabling a user to create question set answers at block 1116.

If at block 1108, the process determines that the user is not a calendar manager, the process determines whether the user is a calendar editor at block 1112, and if so, the process determines whether the plan type is one of a DB, DC, or H&W at block 1114. If it is one of these plan types, the process displays an option for enabling the user to create question set answers related to these plan types at block 1118. If at block 1112 or block 1114, if the user is not a calendar editor or the plan type is not one of a DB, DC, or H&W, the process disables and hides the option for enabling a user to create or question set answers at block 1116.

If the user selects the calendar module block 1106, the process determines whether a plan is associated with the client/entity of the user at block 1120. If the process determines that the plan is not associated with an entity associated with the user, the process disables and hides the option for enabling a user to create, view, or edit question set answers at block 1132.

If the process determines that the plan is associated with an entity associated with the user, the process determines whether the plan type is one of a DB, DC, or H&W plan at block 1122. If the process determines that the plan is not one of a DB, DC, or H&W plan, the process disables and hides the option for enabling a user to create or edit question set answers at block 1132. However, if the process determines that the plan is one of a DB, DC, or H&W, the process determines whether the user is assigned a viewer/editor role at block 1124. If the user is assigned a viewer/editor role, the process will provide an option that will only allow the user to view the question set at block 1128, but not edit. If the user is not assigned a viewer/editor role, the process determines whether the user is assigned a manager role at block 1126, and if so, the process will provide an option that will allow the user to view and edit the question set at block 1130. Otherwise, the process disables and hides the option for enabling a user to create, view, or edit question set answers at block 1132.

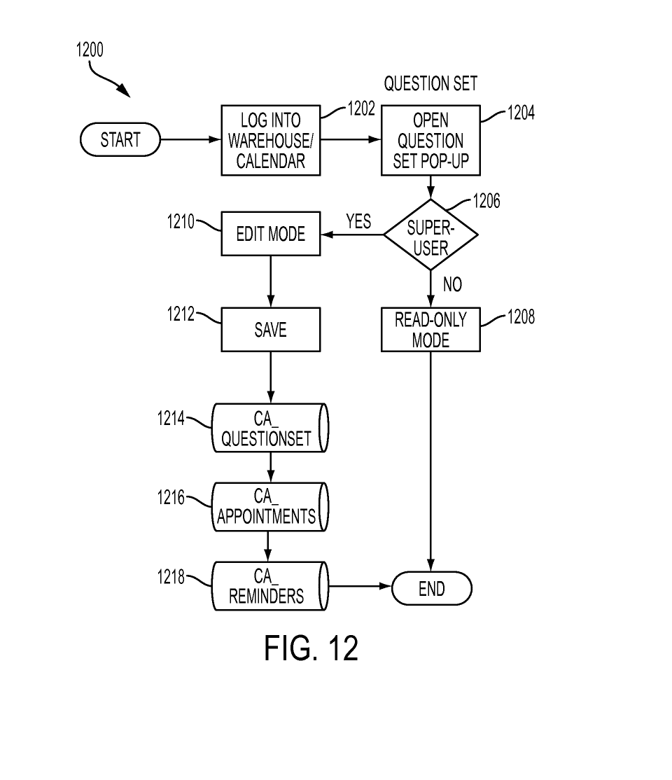

FIG. 12 is a flowchart illustrating a process 1200 that shows the effects of a user editing a question set in accordance with one embodiment. As previously stated, changes in plan provisions or other decisions made by a plan sponsor may affect compliance events for a plan—creation or elimination of events or due dates of events. The saved responses to questions previously used to populate the calendar can be edited to reflect such changes. However, this will repopulate the events on the calendar that are affected by the responses that are changed. In one embodiment, the system automatically populates subsequent years' events, with the user having the ability to alter any question responses for situations that have changed since the prior years' responses.

As described in FIG. 11, in one embodiment, the user may access a calendar question set through the calendar module at block 1202, and assuming that the user is authorized to view the question set, the process presents the question set at block 1204. At block 1206, the process determines whether the user has editing privileges. If the user does not, the process will allow the user to view the question set but not edit at block 1208. Otherwise, the process will allow the user the option to edit the question set answers at block 1210.

Once the user is done editing the answers to the question set, the process at block 1212 performs a save and updates the question set database with the new answers at block 1214. The process then updates calendar events based on the new answers to the question set and saves the updated calendar events at block 1216. The process then updates reminders based on the new calendar events and saves the information about the new reminders at block 1218, with process 1200 terminating thereafter.

FIGS. 13-15 illustrate examples of a question set in accordance with one embodiment. As shown in the illustrated example, the question set may include general information such as, but not limited to, the employer or client's name, whether the plan uses a prototype for filing a determination letter with the IRS, the employer EIN, plan name, plan year, plan type, beginning and ending date (including fiscal year), types of contribution, whether the plan uses participant directed accounts, whether a safe harbor plan applies, whether there are qualified default investment alternative or automatic enrollment arrangement, whether the plan allows for loans, whether the plan has a vesting schedule or an ERISA account, or whether the plan is operated as a qualified separate line of business (QSLOB).

In addition, in some embodiments, the question set may include a set of annual related questions such as, but not limited to, whether there are participants separated with deferred vested benefits, distributions made in prior year, amendments adopted, form 5500 extension requested, and whether a corporate tax return extension has been requested.

Still, in certain embodiments, the question set may include a set of tax reporting related questions such as, but not limited to, the plan sponsor fiscal tax year end date, whether the entity is a corporation or partnership, whether paper or electronic filing is desired for certain filings, whether notification is desired if another person perform certain filings or deposits, and whether the total tax reporting for the prior year was less than $50,000.

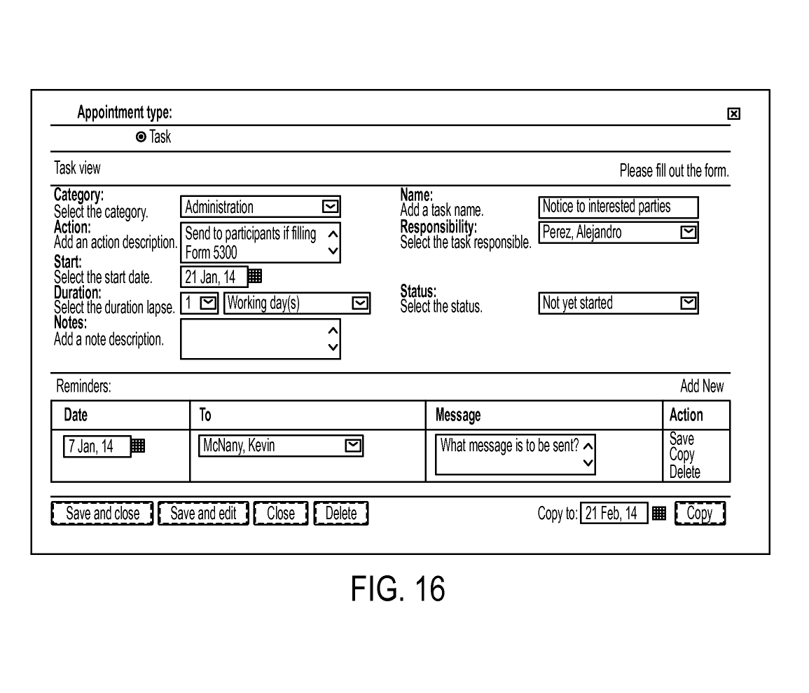

FIG. 16 illustrates a user interface 1600 for enabling a user to enter or edit a calendar event in accordance with one embodiment. In one embodiment, an authorized user can edit all system generated event details—with the exception of certain details within locked events such as events with mandated deadlines by government agencies. Examples of details about an event that can be modified by a user include the event category, event name, event action, start date, duration, end date, status, add additional notes or descriptions. In addition, in one embodiment, the user can modify including add, change, or delete the reminder settings for an event such as when, who, and what message is sent regarding the event. In certain embodiments, the system is also configured to enable the user to copy an entire event to another date or calendar.

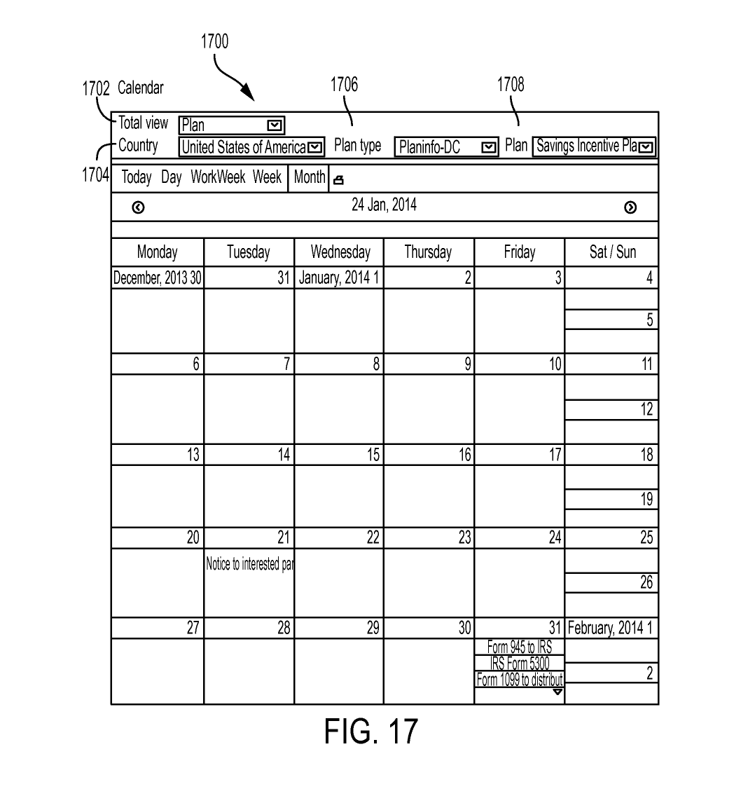

FIG. 17 illustrates an example of a user interface 1700 for displaying a customized calendar of compliance tasks associated with administering a benefit plan in accordance with one embodiment. In some embodiments, the user interface 1700 may include several user selectable options for selecting and viewing compliance tasks associated with a particular benefit plan. For example, in the depicted embodiment, the user interface 1700 may include a total view option 1702, a country option 1704, a plan type option 1706, and a plan option 1708. In one embodiment, the option country option 1704, the plan type option 1706, and the plan option 1708 may be hidden or visible using the total view option 1702 to enable viewing of those options. The country option 1704 enables the user to select the applicable country associated with the benefit plan. The plan type option 1706 enables the user to select a particular plan type such as, but not limited to, defined benefit (DB) plans, defined contribution (DC) plans, and health and welfare (H&W) plans. The plan option 1708 enables the user to select the particular benefit plan.

In addition, the user interface 1700 may include viewing options for viewing the compliance task calendar in several modes including today, daily, workweek, weekly, monthly, and annual calendar views, as well as a list view. As illustrated in the example embodiment, there is one compliance task associated with administering the benefit plan on that occurs on January 21^{st}, as well as several other complaints related tasks that are required to be performed on January 31^{st}. In some embodiments, the user can select a particular day or particular event to view additional details. In some embodiments, the system is also configured to enable the user to create new events. For example, in one embodiment, users may right-click on a date and select new appointment to create a new event.

Still, in certain embodiments, the customized calendar or calendar events may be exported into a second electronic calendar application such as but not limited to Microsoft Outlook. In addition, in some embodiments, the user can print a customized calendar. For example, in one embodiment, the user can create a wall chart, which is an annual summary of all events over a given period of time that can be printed and used as a reference.

Accordingly, the disclosed embodiments provide a technical solution to the problems associated with administering and complying with the requirements of a multitude of benefit plans. In particular, the disclosed embodiments include a system and method of generating a customized calendar of compliance tasks associated with administering a benefit plan. The customized calendar provides event reminders and in some embodiments, automates the tasks of certain events. Thus, using the disclosed embodiments, plan sponsors are more easily able to comply with all the requirements set forth for a benefit plan.

The above disclosed embodiments has been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/blocks may be performed in parallel or out of sequence, or combined into a single step/block. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

Additionally, although specific terms are employed herein, they are used in a generic and descriptive sense only and not for purposes of limitation. For instance, the term “reminder” as described herein is a message that may be sent or executed using any available methodology, and does not imply any particular message form or format. For example, although calendar reminders are described, other types of reminders may be sent or provided to one or more users including but not limited to email, text message, voice messages, fax, printing a physical reminder, automatically setting an alarm or reminder on a user's device such as a smart phone or smart watch, and causing a pop-up reminder window, hologram, video, or a computer generated animation or character to appear and provide the reminder.

In addition, the term database, as used herein, is intended to include any form of organized data, including, but not limited to, data found in tables, charts, spreadsheets, and documents. Furthermore, the term database does not imply the use of a particular or specialized database software nor does it imply the use of any particular data structure.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system configured to generate a customized calendar of compliance tasks associated with administering a benefit plan, the system comprising:
memory for storing computer executable instructions and data; and
a processor for executing the computer executable instructions, wherein the computer executable instructions comprise instructions for:
receiving user-input indicating a user selection of the benefit plan;
retrieving benefit plan data associated with the benefit plan;
receiving answer data indicating answers corresponding to questions associated with the benefit plan; and
generating the customized calendar of compliance tasks associated with administering the benefit plan based on the answer data and the benefit plan data.

2. The system of claim 1, wherein the computer executable instructions further comprise instructions for retrieving a calendar template associated with the benefit plan.

3. The system of claim 2, wherein the calendar template is country specific.

4. The system of claim 1, wherein the computer executable instructions further comprise instructions for:
identifying a question set containing the questions associated with the benefit plan; and
presenting the questions associated with the benefit plan to a user.

5. The system of claim 4, wherein the computer executable instructions further comprise instructions for:
receiving updated answer data indicating changes to the answers corresponding to the questions associated with the benefit plan; and
updating the customized calendar of compliance tasks associated with administering the benefit plan based on the updated answer data.

6. The system of claim 1, wherein the computer executable instructions further comprise instructions for generating a reminder event for a compliance task, wherein the reminder event is configured to send a reminder message to a plurality of specified recipients.

7. The system of claim 1, wherein the computer executable instructions further comprise instructions for automatically performing a compliance task prior to a due date of the compliance task.

8. The system of claim 1, wherein the computer executable instructions further comprise instructions for verifying that that a user has permission to modify the answer data.

9. A computer-implemented method for generating a customized calendar of compliance tasks associated with administering a benefit plan, the method comprising:
receiving user-input indicating a user selection of the benefit plan;
retrieving benefit plan data associated with the benefit plan, wherein the benefit plan data includes requirements associated with the benefit plan;
determining whether the benefit plan is associated with a question set;
identifying the question set containing questions associated with the benefit plan in response to a determination that the benefit plan is associated with the question set; and
presenting the questions associated with the benefit plan to a user;
receiving answer data indicating answers corresponding to questions associated with the benefit plan;
generating, using a processor, the customized calendar of compliance tasks associated with administering the benefit plan using the benefit plan data and the answer data; and
generating a reminder event for a compliance task based on the customized calendar of compliance tasks associated with administering the benefit plan, wherein the reminder event is configured to send a reminder message to a plurality of specified recipients.

10. The computer-implemented method of claim 9, wherein the benefit plan data includes weekend and holiday rules associated with the benefit plan.

11. The computer-implemented method of claim 9, further comprising:
receiving updated answer data indicating changes to the answers corresponding to the questions associated with the benefit plan; and
updating the customized calendar of compliance tasks associated with administering the benefit plan based on the updated answer data.

12. The computer-implemented method of claim 9, further comprising automatically performing a compliance task prior to a due date of the compliance task.

13. The computer-implemented method of claim 9, further comprising verifying that that a user has permission to modify the answer data.

14. A computer-readable storage media having stored thereon computer-executable instructions that when executed by a processor of a system, enables the system to:
receive user-input indicating a user selection of a benefit plan;
receive answer data indicating answers corresponding to questions associated with the benefit plan; and
generate a customized calendar of compliance tasks associated with administering the benefit plan based on the answer data.

15. The computer-readable storage media of claim 14, wherein the computer executable instructions further comprise instructions for:
identifying a question set containing the questions associated with the benefit plan; and
presenting the questions associated with the benefit plan to a user.

16. The computer-readable storage media of claim 15, wherein the computer executable instructions further comprise instructions for:
receiving updated answer data indicating changes to the answers corresponding to the questions associated with the benefit plan; and
updating the customized calendar of compliance tasks associated with administering the benefit plan based on the updated answer data.

17. The computer-readable storage media of claim 14, wherein the computer executable instructions further comprise instructions for generating a reminder event for a compliance task, wherein the reminder event is configured to send a reminder message to a plurality of specified recipients.

18. The computer-readable storage media of claim 14, wherein the computer executable instructions further comprise instructions for automatically performing a compliance task prior to a due date of the compliance task.
